(19) United States
(12) Patent Application Publication
(10) Pub. No.: US 2009/0282829 A1
(43) Pub. Date: Nov. 19, 2009

(54) Gravity wheel

(75) Inventors: Melinda Marie Cameron, Nampa, ID (US); Scott David Bartholdson, Port Orange, FL (US)

Correspondence Address: Melinda Cameron, 204 Juniper St, Nampa, ID, 83686, US

(73) Assignees: Melinda Marie Cameron, Nampa, ID (US); Scott David Bartholdson, Port Orange, FL (US)

(21) Appl. No.: 12/387,954

(22) Filed: May 11, 2009

Related U.S. Application Data
(60) Provisional application No. 61/071,802, filed on May 19, 2008.

(51) Int. Cl. F03G 7/10

(52) U.S. Cl. 60/721; 415/916

(57) ABSTRACT

The Gravity Wheel is a system/cycle of weights that either accept or deny the force of gravity relevant to their position on the wheel itself. The forward motion of the wheel simultaneously is produced by the gravity while it dictates the constant production of energy due to the nature of the motion utilizing the concept of a shifting fulcrum.

### CROSS-REFERENCE TO RELATED APPLICATIONS

This application claims priority to U.S. Provisional Application No. 61/071,802, entitled “Gravity Wheel” and filed on May 19, 2008, the disclosure of which is hereby incorporated in its entirety by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

In an endeavor to produce a means of energy that is without the need for any usable fuel rendering it environmentally friendly and ultimately universal the Gravity Wheel is designed to accomplish all this.

1. Field of the Invention

The Gravity Wheel is intended for use anywhere that energy is needed, having no requirement other than the wheel itself and gravity, therefore any and all static applications and some dynamic applications for energy production will be possible using the Gravity Wheel.

2. Description of Related Art

Not Applicable

### BRIEF SUMMARY OF THE INVENTION

The Gravity Wheel is a device based on the principle of water and wheel and utilizing a “shifting fulcrum” which allows the wheel to turn due to the offset weight distribution provided by the shifting of the fulcrum. The arms of the Gravity Wheel open and fill with gravity as though it were water and when the arms close they expell the gravity and the wheel turns. This chain of events is continuous based upon the opening and closing of the arms, hence the shifting fulcrum. The wheel itself will spin constantly and with ample force to drive electrical generators of varying sizes and output based upon the size and application of each Gravity Wheel.

### BRIEF DESCRIPTION OF THE DRAWINGS

FIG. 1 illustrates the side view of the Gravity Wheel including axis of rotation, arms, weights, and adjustable rollers,

FIG. 2 illustrates the math behind the concept of the shifting fulcrum for the Gravity Wheel

### DETAILED DESCRIPTION OF THE INVENTION

As Isaac Newton discovered, the force of gravity is powerful, enough so to hold our moon in its orbit. Thirty-two feet per second is the acceleration rate of gravity—that acceleration (a), when imposed upon a given object of mass (m), results in force (F) according to F=m·a. The advent of a fulcrum allows leverage to enable a lesser weight to move a greater one.

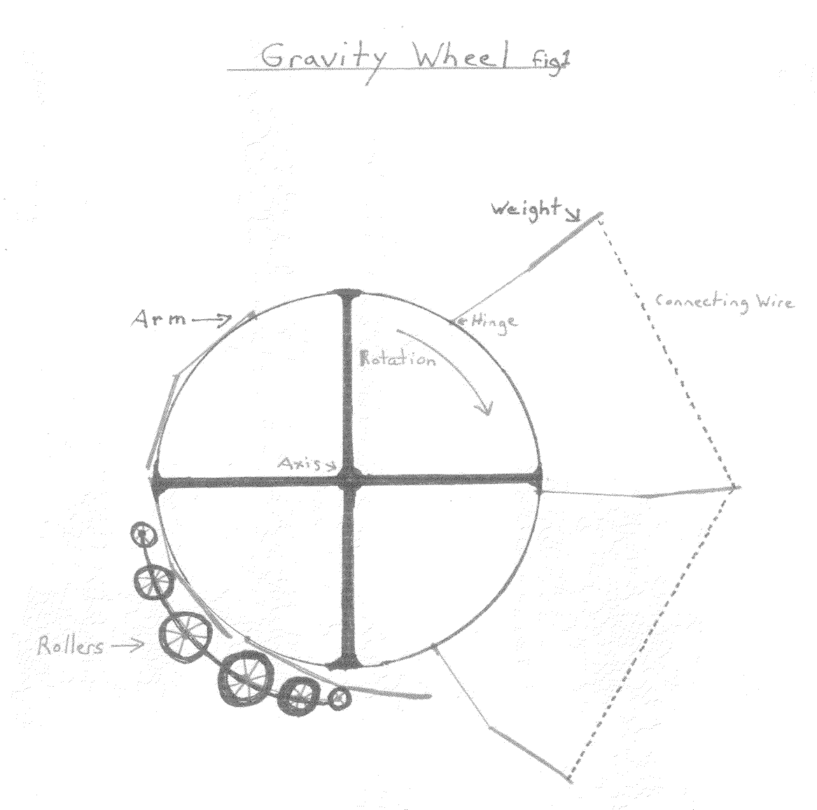

As gravity pulls a weight of a given amount—an equal weight is lifted because of leverage and excess force is generated. The force that is produced repeats as another weight is introduced; each weight produces excess force and the cycle continues. In rotation a new weight is introduced, the fulcrum shifts, and weight is transferred. As water fills a water wheel the wheel turns—as long as water is supplied the wheel will continue to rotate. In the same manner, the gravity wheel utilizes weights connected to arms to turn (see FIG. 1). In the same way that a water wheel takes on water then expels it, the gravity wheel positions its weights so as to allow the force of gravity to push downward—turning the wheel.

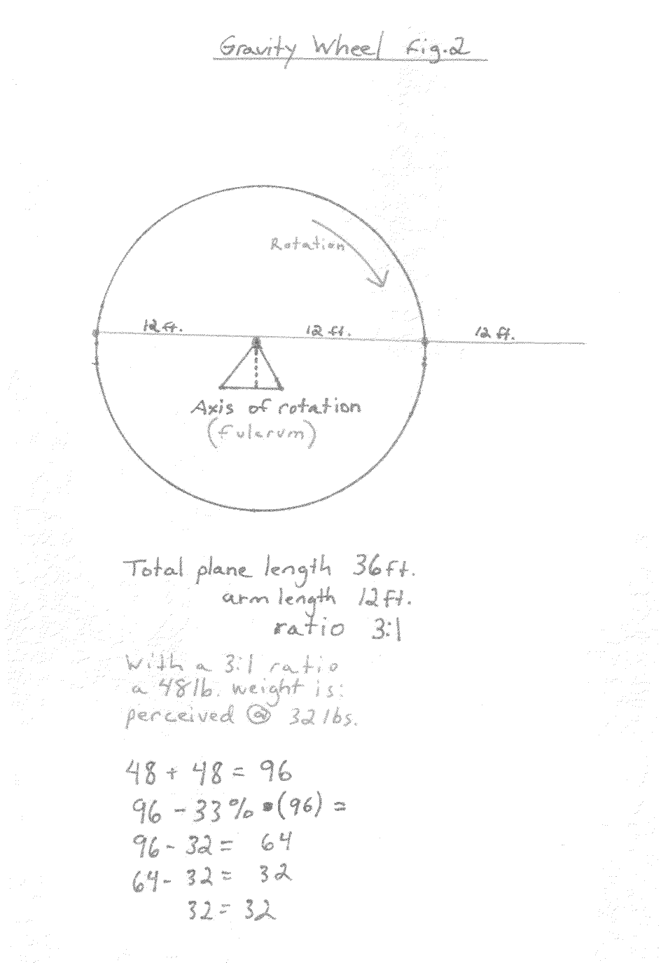

As a fulcrum allows the same weight to appear either heavier or lighter depending upon its position, the axle of the gravity wheel acts as a fulcrum. A series of arms extend weights as to allow them to appear heavier in the downward direction, and as the wheel rotates, the arms are pressed against the outside of the wheel itself through a series of adjustable rollers, reducing the weight during the upward direction (see FIG. 1). The principal is simple; the downward side of the wheel is heavier than the upward side—and so it turns. Additionally, as the weights are pressed against the upward side of the wheel, centripetal force is created (similar to pulling ones legs in as one spins in a chair). This force, combined with the downward force, and momentum creates circular motion. To illustrate this mathematically see FIG. 2.

What is claimed is:

1. The Gravity Wheel is a device that spins via the force of gravity to produce enough energy to drive a generator(s) of various sizes depending upon the application.

2. The Gravity Wheel presents a scenario which no claims can be made in relation to any other device of its type because due to the description, functionality and application of the Gravity Wheel nothing exists to compare it to or make claims in any related capacity.

3. It remains to be seen that when the Gravity Wheel is proven to do what is claimed any variation of the Gravity Wheel by any machine would most likely be based upon the design, functionality, and application of the first of its type—the Gravity Wheel.
